(19) United States
(12) Patent Application Publication
(10) Pub. No.: US 2004/0124376 A1
(43) Pub. Date: Jul. 1, 2004

(54) Real time explosive detection system

(75) Inventors: Oleg Valentinovich Ershov, Moscow (RU); Alexander Ivanovich Nadezdinskii, Moscow (RU); Andrei Georgievich Berezin, Moscow (RU); Steven P. Kadner, Albuquerque, NM (US)

Correspondence Address: CARSTENS YEE & CAHOON, LLP, P O BOX 802334, DALLAS, TX, 75380

(73) Assignee: Canberra Auila Inc., Albuquerque, NM

(21) Appl. No.: 10/330,631

(22) Filed: Dec. 27, 2002

(51) Int. Cl. G01J 1/00

(52) U.S. Cl. 250/554

(57) ABSTRACT

A system and an apparatus for detecting explosive in real time is provided for. The apparatus involves a chamber in which items pass through or people walk through for detecting said explosive particles in real time. The explosive particles from either the people or items will be deposited into a cell by an influx of air flow from the chamber flowing to the cell. The cell includes a heating device and an optical scheme. The cell is heated to a predetermined temperature in which the explosive particles are divided into small molecular components that can be detected. The optical scheme detects the smaller molecules. The computer system controls the apparatus and analyzes the data gathered.

### BACKGROUND OF THE INVENTION

1. Technical Field

The present invention relates to detecting a molecule present in the air. More specifically the invention relates to a laser device for detecting explosive particles. The device is controlled by a computer system.

2. Description of the Related Art

The colors of an object typically arise because materials selectively absorb light of certain frequency, while scattering or transmitting light of other frequencies. For example an object is red (wavelength range from 6300 and 6800 Å) if it absorbs all visible frequencies except those our eyes perceive to be “red.” Thus, we see the scattered wavelength range from 6300 and 6800 Å from that object.

Similarly, molecules absorb at different frequencies. A predefined range of wavelength propagating through gas molecules are absorbed at the resonance frequencies of the atoms or molecules, so that one observes gaps in the wavelength distribution of the emerging wavelengths. Absorption lines of a molecule have its own intensity and spectral position. In detecting a molecule using laser technology, the laser radiates frequencies near the absorption line to amplify the sensitivity of the detection.

Increasingly, more people are relying on airplanes as a mean for transportation to a distant destination. Airport personnel are vigilant about the security of the airport and the flight itself. Everyone and their carried on baggage must go through metal detectors before going to the departure gate and board on the airplane. The metal detector helps in finding guns and knives but it cannot detect explosives. The detection for explosives should not be intrusive and applies to everyone and their luggage when they decide to fly.

### SUMMARY OF THE INVENTION

The present invention provides a system and an apparatus for detecting explosive in real time. The apparatus involves a chamber in which items pass through or people walk through for detecting said explosive particles in real time. The explosive particles from either the people or items will be deposited into a cell by an influx of airflow from the chamber flowing to the cell. The cell includes a heating device and an optical scheme. The cell is heated to a predetermined temperature in which the explosive particles are divided into small molecular components that can be detected. The optical scheme detects the smaller molecules. The computer system controls the apparatus and analyzes the data gathered.

### BRIEF DESCRIPTION OF THE DRAWINGS

FIG. 1 is a block diagram of explosive particle detector according to an embodiment of the present invention.

FIG. 2 is a block diagram of an optical scheme according to an embodiment of the present invention.

FIG. 3 is a block diagram of a computer system according to an embodiment of the present invention.

FIG. 4 is a block diagram of an particle detector controller in accordance with an embodiment of the present invention.

FIG. 5 is a pictorial representation of particle detector in accordance with an embodiment of the present invention.

FIG. 6 is a pictorial representation of interface module in accordance with an embodiment of the invention.

FIG. 6(a) is a DL current supply in accordance with an embodiment of the present invention.

FIG. 6(b) is a resistance-voltage transformer in accordance with an embodiment of the present invention.

FIG. 6(c) is a peltier supply in accordance with an embodiment of the present invention.

FIG. 7 is a pictorial representation of a photodetector transformer/amplifier unit in accordance with an embodiment of the invention.

FIG. 8 is a block diagram of software in accordance with an embodiment of the invention.

FIG. 9 is a flowchart of signal processing in accordance with an embodiment of the invention.

FIG. 10 is a flowchart for calculation of particle concentration in accordance with an embodiment of the present invention.

FIG. 10a is an absorption profile.

FIG. 11 is a flowchart for DL temperature stabilization in accordance with an embodiment of the present invention.

### DETAILED DESCRIPTION

The description of the preferred embodiment of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention the practical application to enable others of ordinary skill in the art to understand the invention for various embodiments with various modifications as are suited to the particular use contemplated.

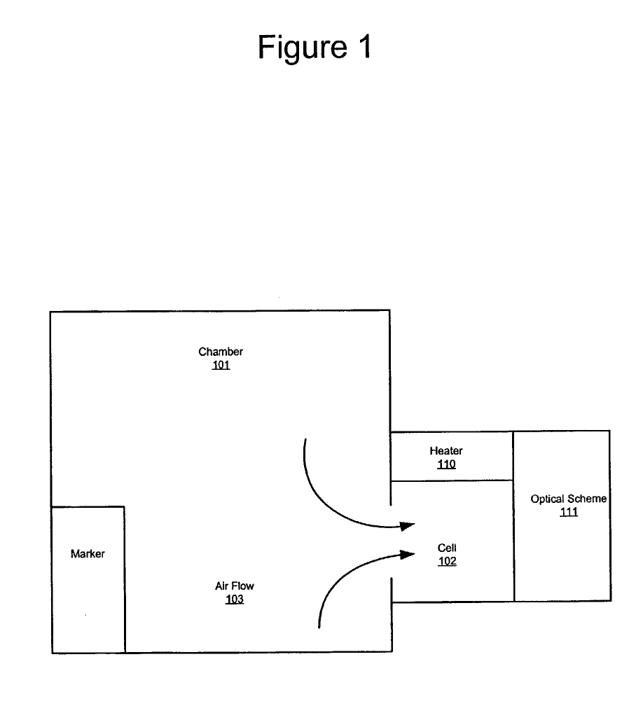

With reference now to the figures and in particular with reference to FIG. 1, a pictorial representation of explosive particle detector 100 in accordance with an embodiment of the presentation of optical scheme is illustrated. Explosive particle detector 100 includes detection chamber 101, cell 102, and airflow 103. Detection chamber 101 is an enclosed area in which items such as luggage and packages may pass through by entering the chamber for explosive detection in real time thereafter it exits the chamber. This could be achieved by putting the items on a conveyor belt capable of transferring the items from one place to other. If an item is detected to contain explosive, it is marked as such, removed from the chamber for further inspection and required to follow appropriate security measures. If an item does not contain explosive, it exits the chamber without being marked and continues its appropriate journey.

The chamber 101 is connected to cell 102. Cell 102 includes heater 110 and optical scheme 111. Air flows from the chamber into the cell. Air flow 103 can be achieved by cell 102 having a vacuum mechanism to influx air into the cell 102 or air is blown from the chamber 101 into the cell 102 or a combination thereof. Because of the airflow, explosive particles, will be deposited in the cell 102 in which heater 110 and optical scheme 111 works together to detect the presence of explosive particle. Heater 110 heats up the cell to a temperature degree in which the explosive particles are divided into smaller molecular components.

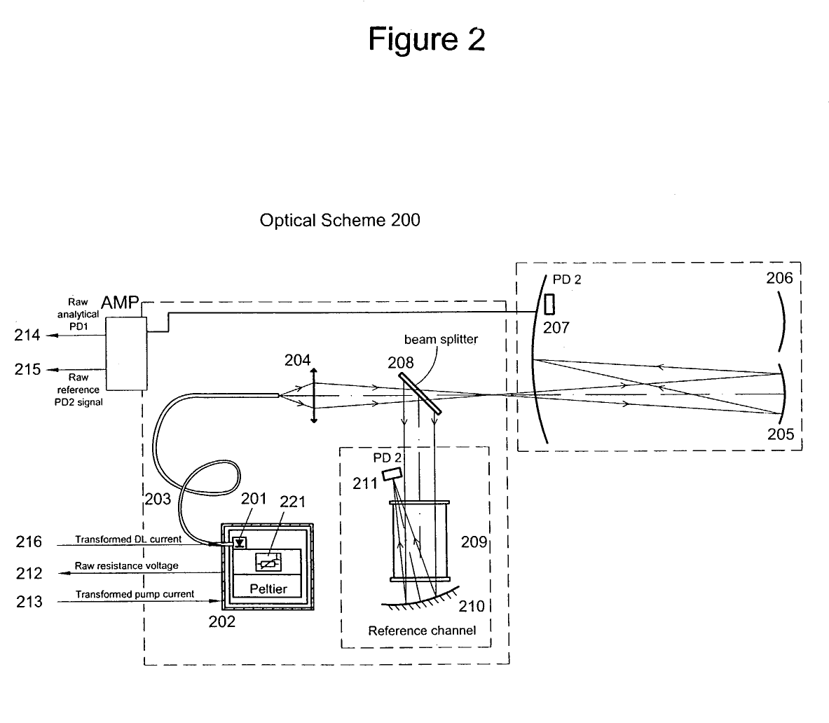

FIG. 2 shows a pictorial representation of optical scheme 200 in accordance with an embodiment of the present invention. This figure corresponds to optical scheme 111 of FIG. 1. Optical scheme 200 involves diode laser (“DL”) 201 assembled a thermistor 221, a temperature sensitive resistor. Diode laser 201 radiating power is proportional to transformed DL current 216. Diode laser 201 wavelength depends on the temperature of the diode laser 201. Thermistor 221 sets and adjusts the temperature for diode laser 201 with the raw resistance voltage 212. Other temperature stabilizing components can be substituted for thermistor 221. Diode laser 201 and thermistor 221 are housed inside thermostatic enclosure 202. Thermostatic enclosure 202 helps to keep the temperature of the assembly constant without the effect of the changing temperature of the outside environment. Outside of thermostatic enclosure 202, the optical scheme further includes optical components for analytical optical scheme.

In the analytical optical scheme, diode laser scanning radiation frequency 202 is channel into single mode fiber 203 of about two meters long. Single mode fiber 203 narrows the concentration of radiation in which the inhomogenity of DL radiation is 0.3%, thereby optical filters are not required. The output of the single mode fiber 203 is diverged at a 20° angle obeying the Gaussian law. Then the radiation is passed through objective 204 to be adjusted by refraction in order to fully illuminate the cube reflector 205. Between objective 204 and reflector 205, the radiation may have pass through an enclosure, for example, cell 102. The absorption of the particle occurs for the first time. In a preferred embodiment of the present invention, particle molecules may be detected here. The reflected radiation fully illuminates spherical mirror 206 having a 6.5 cm diameter, which is positioned behind objective 204. The optical path between reflector 205 and spherical mirror 206 undergoes a second absorption of the particle inside the enclosure. Because radiation passes through the enclosure twice, the absorption of the particle amplifies. Spherical mirror 206 focuses the absorbed radiation on the sensing area of analytical photodetector 207. Then, photodetetor 207 generates raw analytical PD1 signal 214.

Those of ordinary skill in the art will appreciate that the detector is capable of detecting explosive and drug particles by the above optical scheme incorporating Tunable Diode Laser Spectroscopy or Fourier Transform Spectroscopy.

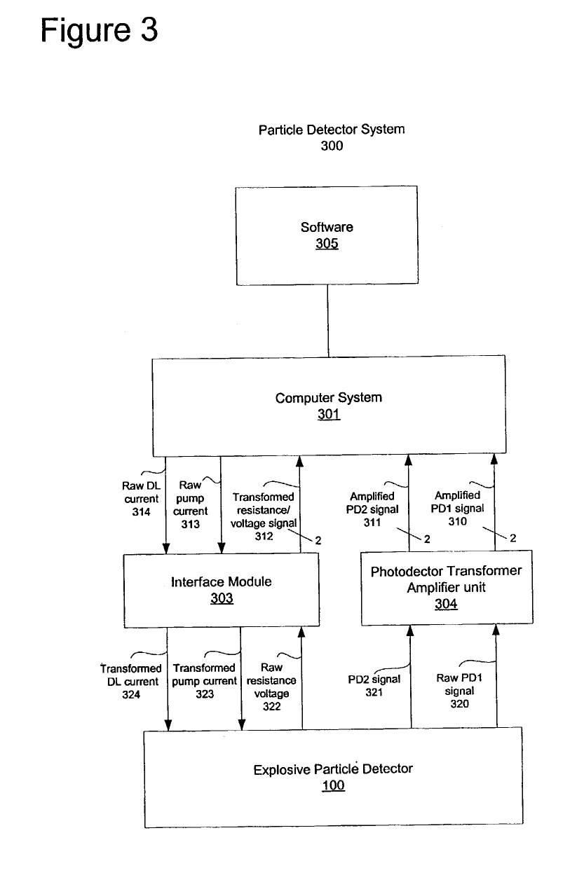

Referring now to FIG. 3, a block diagram of an explosive particle detector system is shown in accordance with a preferred embodiment of the present invention. Particle detector system 300 includes computer system 301, optical scheme 302 (which corresponds to optical scheme 111 and 200), interface module 303, photodetector transformer amplifier unit 304, and software 305. Software 305 initializes and synchronizes particle detector system 300. It also provides for particle detector system signal processing and storing and analyzing data. Computer system 301 provides processing and control to particle detector system 300. There are signals communicating between computer system 301 and optical scheme 302. These signals must pass through interface module 303.

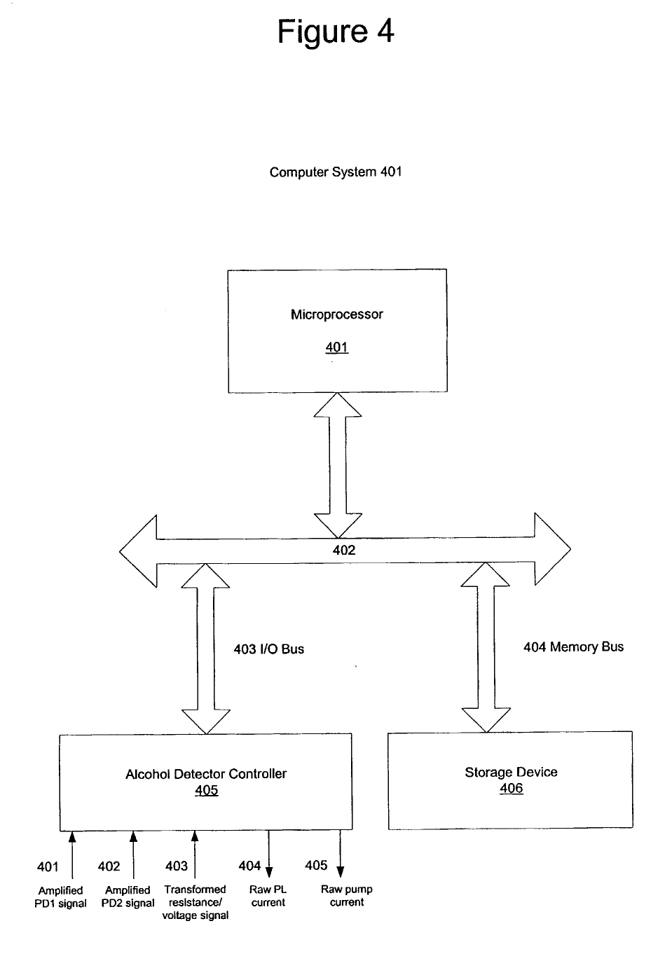

Referring now to FIG. 4, a block diagram of a computer system 301 is shown in accordance with a preferred embodiment of the present invention. Computer system 301 may employ a single microprocessor 401, or in the alternative, multiple microprocessors on the system bus 402. A storage device is connected to a memory bus 404. An input/output (“I/O”) device may be integrated to the I/O bus 403 as depicted. A storage device includes memory devices such as hard disk drive 406. I/O device includes a particle detector controller 405 for assisting in the control of a particle detector. Computer system 301 controls and communicates with the particle detector.

Those of ordinary skill in the art will appreciate that the hardware depicted in FIG. 4 may comprise of multiple microprocessors, multiple storage devices, or multiple I/O devices. These devices may vary. For example, other peripheral devices, such as optical disk drives and the like, also may be used in addition to or in place of the hardware depicted. The depicted example is not meant to imply architectural limitations with respect to the present invention.

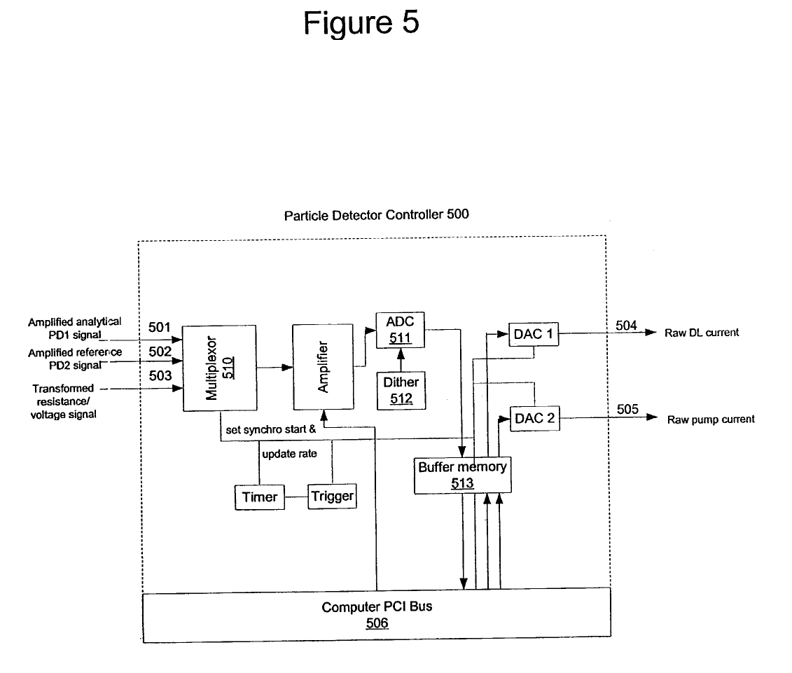

Referring now to FIG. 5, a block diagram of a particle detector controller 405 is illustrated. A multiplexor 510 allows successive connecting of inputs to analog to digital converter (“ADC”) 511 with set update rate, which value can't exceed a predetermined sampling frequency, 1.25 MHz. Next, dither 512 may be used for smoothing of bits in ADC 511 output signals. A timer controlled by software serves as clock cycle for particle detector controller 405. It may include a frequency divider that allows for frequency adjustments of output signal generation and data acquisition. The timer controls a trigger. It serves as a signal to synchronize the signal generation and data acquisition. If this triggering synchronization switches at a common frequency, it creates an operational frequency for the particle detector controller 405.

With regards to controller's outputs, data are stored in buffer memory 513. A predetermined pulsed signal for DL current pulse is stored in buffer memory 513 for DL current. The data stored in the buffer memory 513 flows to the first digital-to-analog converter (“DAC1”). DAC1 supplies continuous train of raw DL current 504. Controller 405 is installed in the computer PCI bus 506 and connected with Interface module and photodetector transformer/amplifier unit. Data exchange between controller 405 and computer through reads and writes of controller's 405 buffer memories 513. In a preferred embodiment of the present invention, controller 405 is configured from a standard multifunctional NI-DAQ board of the PCI-MIO-16E-1 produced by National Instruments, Inc.

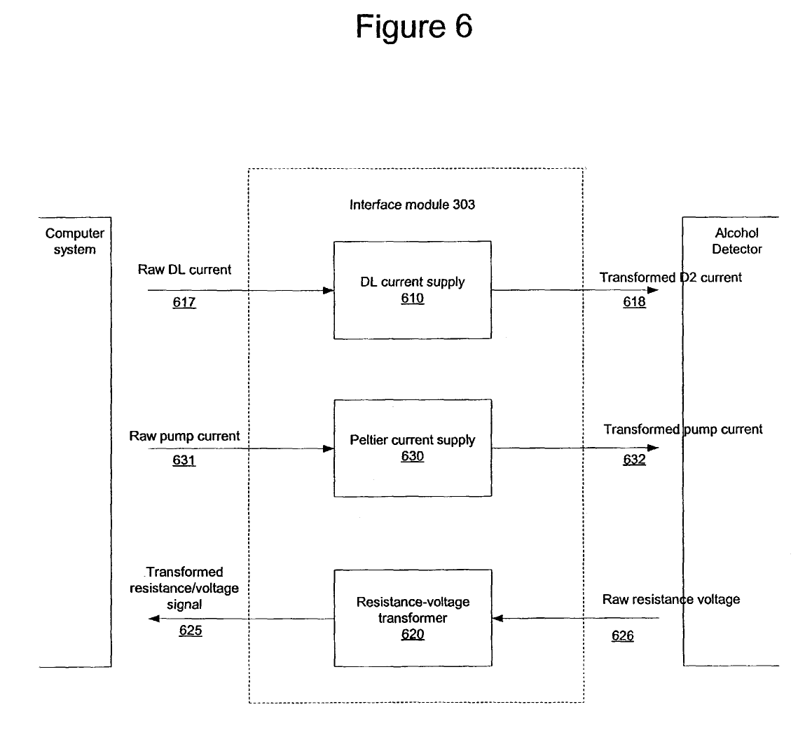

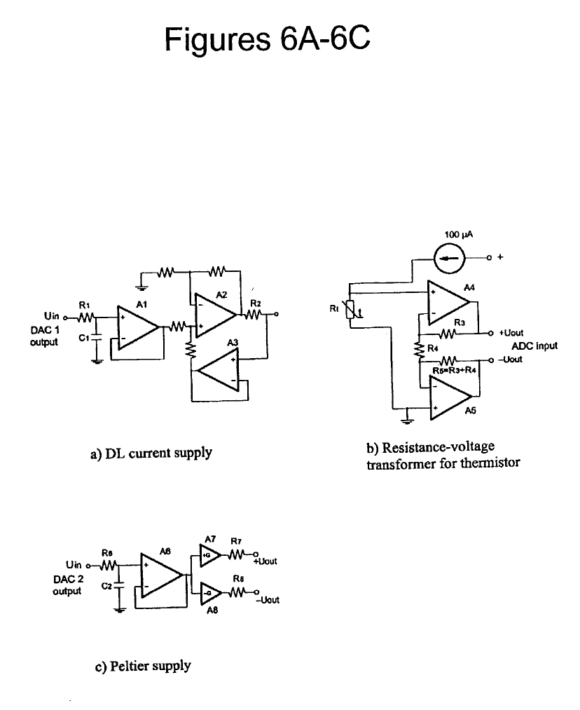

Referring now to FIG. 6, a pictorial representation of interface module 303 in accordance with an embodiment of the present invention is illustrated. Interface module 303 involves three analog units: DL current supply 610, resistance—voltage transformer 620, and peltier current supply 630. Interface module 303 provides interface for three signals between the optical scheme 200 and particle detector controller 405. In FIG. 6(a), DL current supply amplifies 610 and transforms the pulse of raw DL current 617 into pulses of amplified DL current 618 feeding optical scheme. It includes three operational amplifiers, 611-613. Resistance R1 614 and capacitance C1 615 define frequency bandwidth. Resistance R2 616 defines the current/voltage transformation factor. The output operational amplifier A₂ 613 and resistor R₂ 616 are chosen thermo stable for preventing drift of output parameters.

Two other units of interface module 303, resistance—voltage transformer 620 is intended for stabilizing and adjusting the diode laser temperature. The temperature of thermistor having good thermal contact with diode laser in optical scheme 200 is measured in the Resistance/Voltage Transformer unit 620 as depicted in FIG. 6(b). Resistance—voltage transformer unit 620 includes two operational amplifiers 621 and 622 and stable current supply 623. Current supply 523 ensures that a current of 100 uA flows the thermistor Rₜ 624. Resistance—voltage transformer unit 620 transforms raw resistance—voltage signal 626 into a voltage value for transformed resistance—voltage signal 625. Transformed resistance—voltage signal 625 transmits to Controller 405 as one of the inputs, which is later transformed into degree value in the device software.

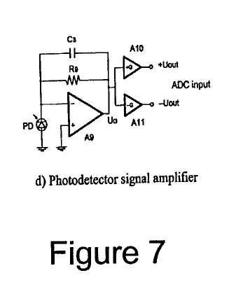

Referring now to FIG. 7, a pictorial representation of a photodetector transformer/amplifier unit 304 in accordance with an embodiment of the present invention is illustrated. Photodetector transformer/amplifier unit 304 transforms raw analytical PD1 signal 701 into differential amplified analytical PD1 signal 703. Amplified analytical PD1 signal 703 is an input to Particle Detector Controller 405. Base scheme of these transformer-amplifiers is shown at FIG. 7. The first stage of the scheme is typical transimpedance amplifier A9 where R9 and C3 are feedback resistance and capacitance respectively. Amplifier frequency bandwidth is defined by capacitance C3, transfer factor at low frequencies is defined by resistance R9. Second stage of the scheme is voltage amplifiers A10 and A11 for generating differential outputs. Photodetector transformer/amplifier unit 304 is also battery-powered for providing high signal to noise ratio.

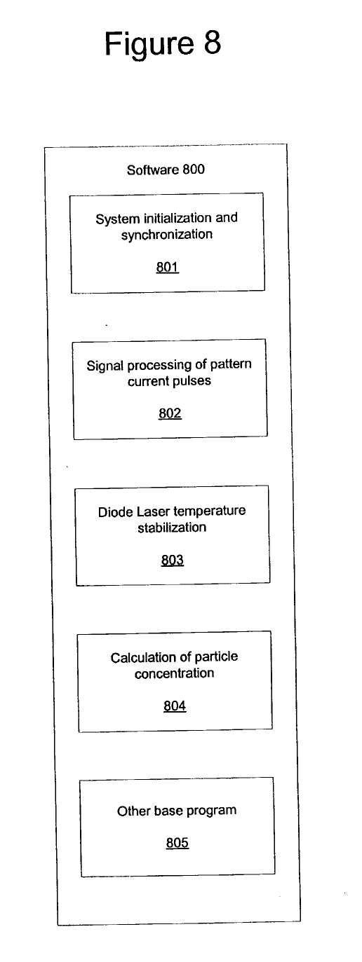

Referring now to FIG. 8, a block diagram of software 305 in accordance with an embodiment of the present invention is illustrated. Software 801 initializes and synchronizes particle detector system 300. It also provides for particle detector system computer program instruction for signal processing 802, diode laser temperature stabilization 803, calculation of particle concentration 804 and other operations are produced in the base part of the program 805.

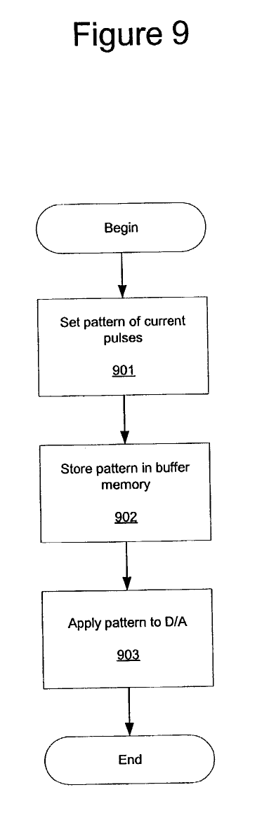

Referring now to FIG. 9, a flowchart of signal processing 802 according to an embodiment of the present invention is illustrated. The software provides instructions for signal processing for generating the pattern of pulses of DL current (step 901). The pulse pattern period must in proportionate to the digital to analog converter update rate. The pattern is then stored in the particle detection controller's buffer memory (step 902). The software further provides instructions for applying the pattern to the particle detection controller's digital to analog converter (step 903). The DAC in the particle detector controller, transform the pulsed pattern into a continuous raw DL current.

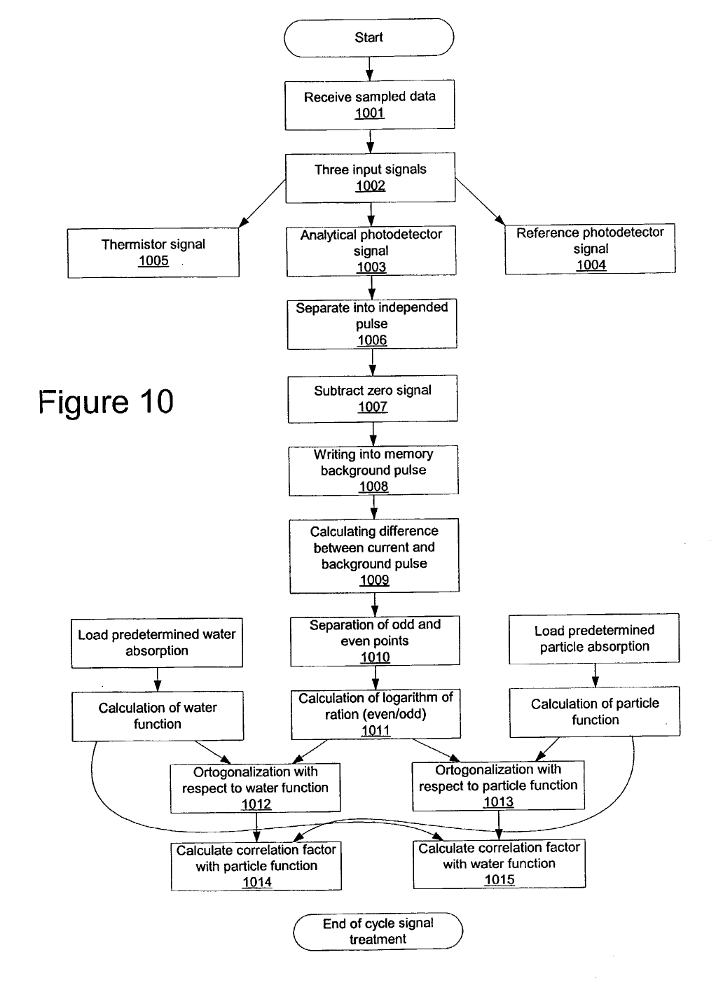

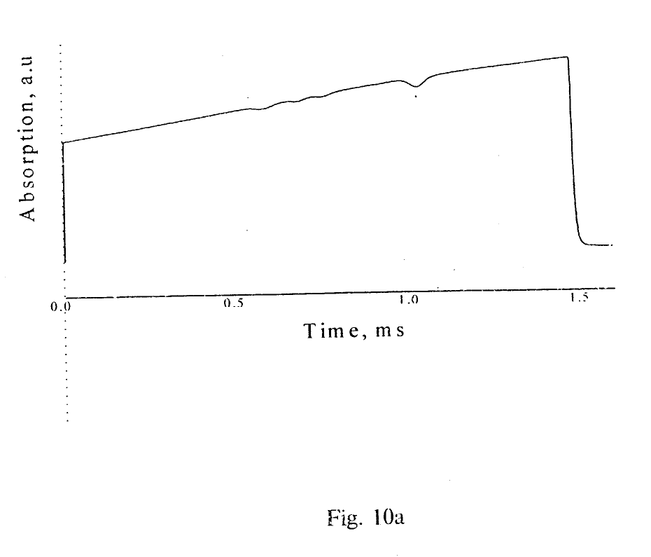

Referring now to FIG. 10, a flowchart for calculation of particle concentration 804 according to an embodiment of the present invention is illustrated. The process for calculating particle concentration starts with the receipt of sampled data from the analytical photodetector signal at beginning of the current pulse (step 1001).

Three controller inputs (step 1002): (1) photodetector signal from analytical channel (step 1003), (2) photodetector signal from reference channel (step 1004), (3) signal proportional to thermistor resistance (step 1005), are used in the present invention. The signals are applied to the controller ADC successively, so sampling frequency of each input is three times lower than the controller update rate and equals 166.6 kHz. Pulse duration in photodetector signals includes 500 points, duration between adjacent pulses includes 100 points, and pulse repetition period includes 600 points. Modulation period in the signals is two times more than duration between adjacent points; so even points form one branch (low), odd points form another branch (high).

The first channel contains sampled analytical PD1 signals made up of a train of pulses having 3.6 ms period (step 1003). The software separates the pulses for independent treatment of each pulse (step 1006) according to a period or cycle of a pulse. In step 1007, the value of “zero signal” between two pulses is subtracted from each of the points respectively. “Zero signal” is PD signal when laser is switched off. This signal includes photodetector preamplifier output shift and value connected with illumination of photodetector by other light sources. The value of zero signal is averaged by 100 points between two adjacent pulses. Step 1007 lessens interference of photodetector illuminated by another sources (i.e. light illumination reflected by pieces of glass or car windows). The result from subtracting zero signal is saved as background pulse (step 1008). Next the process calculates the difference between the background pulse and the raw current (step 1009). The independent pulse is separated into two arrays: (a) an odd array for storing all the odd points and (b) an even array for storing all the even points. The logarithm of the ratio of respective even points over odd points (e.g. Ln(even/odd)) is calculated in step 1010. The logarithm value is proportional to the difference of absorptions at the branches wavelength ranges and would lessen any low-frequency signal interference from mechanical vibration or interfering illumination. Steps 1013 through 1020 take the signal from the reference photodetector and perform the same steps that have been done on the analytical photodetector signal. That is, the signal is separated into independent pulses (step 1016), the zero signal is subtracted (step 1017), the results is saved a background pulse (step 1018), the difference between the background pulse and the raw current are calculated (step 1019) and the logarithm of the reference signal is calculated (step 1020). Finally, the calculated logarithms of both the analytical signal and the reference signal are used to calculate the correlation factor with reference function (step 1015). This ends the cycle.

DL temperature variations directly affect the DL radiation wavelength variation. The stabilization of DL temperature ensures that DL will operate in the stable range near the maximum particle absorption band at 1.39268 um. FIG. 10a illustrates an absorption profile.

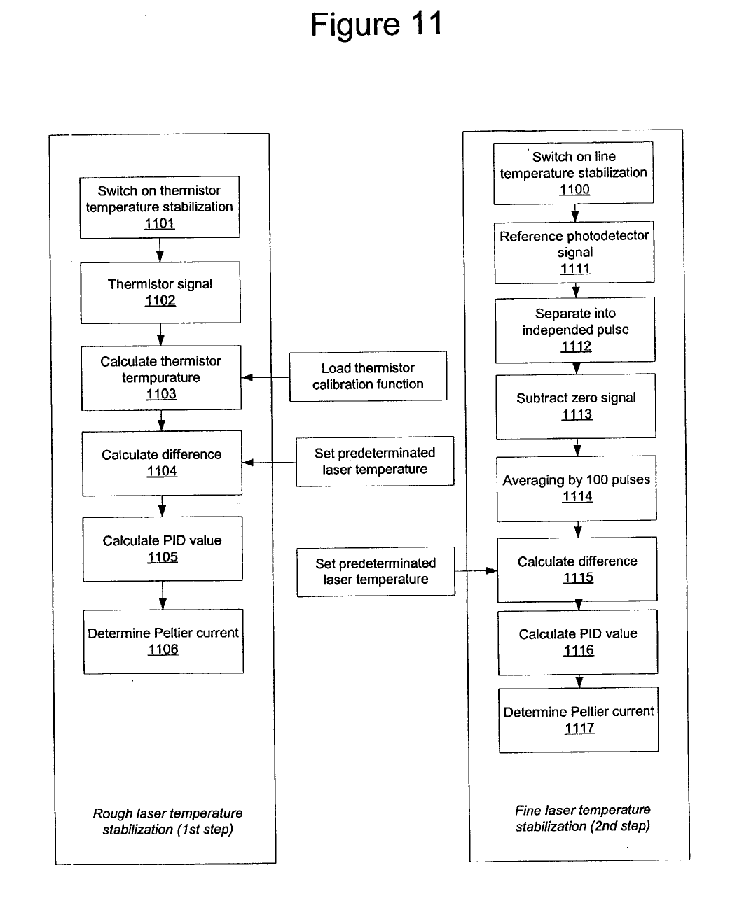

Referring now to FIG. 11, a flowchart for DL temperature stabilization 803 according to an embodiment of the present invention is illustrated. Initially, the diode laser's temperature is set with the help of the thermistor (step 1101). First the process receives the transformed resistance/voltage signal (step 1102) from thermistor. With a predetermined load thermistor calibration function, the thermistor's actual temperature can be calculated (step 1103). Then with a set predetermined laser temperature and thermistor's actual temperature, the process calculates the temperature difference (step 1104). Next, the process calculates the PID (Proportion, Integral, Derivative) value (step 1105) in order to determine the pump current (step 1106). Initially, the diode laser and thermistor should have the same temperature until the diode laser generates more heat in which the temperature of the two components differs. As a result, thermistor's temperature is stabilized and not the diode laser. After the initial setting of the temperature, the process switches to line stabilization position (step 1110) for stabilizing DL temperature. The absorption line position within a recorded pulse is an unbiased criterion of DL true temperature. First, it receives the sampled data from amplified reference PD2 signal (step 1111). Each pulse is separated from the other (step 1112) for subtraction from zero signal (step 1113). The process repeats step 1113 one hundred times (100×) for one-hundred pulse period before it takes the average value (step 1114). Next, with a preferred predetermined laser temperature and the calculated average value, the temperature difference is calculated (step 1115). Then the PID value must be calculated (step 1116) before the determination of pump current (step 1117). The difference between current absorption line position and predetermined one come to the input of PID (Proportion, Integral, Derivative) program module. Value from output of this module is applied to DAC 2 for feeding Peltier element. This value at n step of the program cycle (Vₙ) is calculated in conformity with formula:

Vₙ=a*Pₙ+b*Iₙ+c*Dₙ

where Pₙ is the difference (see above) at n step of the program cycle,

$${I}_{n} = {\sum }_{0}^{n} {P}_{i} ,$$

Dₙ=Pₙ−Pₙ₋₁, a, b, c-factors.

Because Pump current is not constant and must be determined, Pump current is tunable and directly stabilizes DL temperature. The determined Pump current is applied DAC2 on the controller in which the Pump current is made continuous before channeling to the interface module. DL temperature variations directly affect the DL radiation wavelength variation. The stabilization of DL temperature ensures that DL will operate in the stable range near the maximum particle absorption band.

Although preferred embodiments of the present invention have been described in the foregoing Detailed Description and illustrated in the accompanying drawings for particle detection, it will be understood that the invention is not limited to the embodiments disclosed, but is capable detecting other gas molecules which may require numerous rearrangements, modifications, and substitutions of steps without departing from the spirit of the invention. For example, each gas molecule having distinct absorption band would require a diode laser radiating at or near that band, the photodetector functions at the distinct absorption band, the predetermined DL current may differ in the sampled points and duration, the reference cell may differ in content. Accordingly, the present invention is intended to encompass such rearrangements, modifications, and substitutions of steps as fall within the scope of the appended claims.

What is claimed:

1. An apparatus for detecting explosive particles in real time comprising:
a detecting chamber wherein items pass through for detecting said explosive particles in real time;
a cell coupled with an optical scheme wherein said optical scheme detects absorption bands of molecules present in said cell;
an air flow from said detection chamber into said cell wherein explosive particles deposit into said cell for detection; and
a processor coupled to said optical scheme to interpret said absorption bands.

2. The apparatus as recited in claim 1 wherein said explosive particles detector further comprises a heater couples with said cell wherein explosive particles are divided into smaller molecular components to be characterized and identifies.

3. The apparatus as recited in claim 1 wherein said optical scheme further comprises:
a diode laser for emitting radiation at a maximum absorption band of said explosive particles wherein said radiation is tunable by adjusting the temperature of said diode laser; and
a single source fiber coupling to said diode laser for narrowing wavelength range of said radiation wherein said remote gas molecule detector does not require an optical filter.

4. The apparatus as recited in claim 1 wherein said optical scheme further comprises:
a first connection for a first current into the diode laser; and
a second connection for a second current adjusting the temperature of the diode laser.

5. The apparatus as recited in claim 3 wherein said second current is tunable for a maximum absorption band of particle.

6. The apparatus as recited in claim 1 wherein said optical scheme further comprises:
an optical splitter receiving the emitted radiation and producing a first and second optical channels;
a first detector detecting the presence of said explosive from the first optical channel; and
a second detector for reference from the second optical channel.

7. The apparatus as recited in claim 6 wherein said first detector detects the presence of explosive particles.

8. The apparatus as recited in claim 1 wherein a person at a time passes through a second detection chamber for detecting said explosive particles in real time.

10. The apparatus as recited in claim 1 wherein said detecting chamber couples with an air blower for directing air into said cell wherein maximum explosive particles deposits in said cell.

11. The apparatus as recited in claim 1 wherein said detecting chamber couples with a marker to identify item when said item was detected to contain explosive particles for further investigation.

12. The apparatus as recited in claim 1 wherein said cell further couples with an air vacuum for directing air from said detecting chamber into said cell wherein maximum explosive particles deposits in said cell.

13. The apparatus as recited in claim 6 wherein said first optical channel is capable of passing twice through said cell to detect said particles, whereby the absorption of said particles is amplified.

14. A computer system for controlling a real time explosive particles detector, said computer system comprising:
a microprocessor for running software wherein the software analyzes the data from photodetectors and controls said explosive particles detector;
an explosive particles detector controller for transforming data between said explosive particles detector and the computer system; and
a storage device for storing predetermined diode laser pulsed current and analyzed data.

15. A computer system as recited in claim 14 wherein said explosive particles detector further comprises:
an analog to digital converter for sampling inputs into digitized data for storage in said computer system wherein said digitized data will be analyzed according to an absorption band of said explosive particles; and
a digital to analog converter for converting stored data into continuous data, wherein the continuous data couples to an input of said explosive particles detector.

16. A explosive particles detector system with an explosive particles detector, said system comprising:
a explosive particles detector wherein results of detection is in real time;
a computer system for running a software wherein the software analyzes the data from photodetectors and controls said explosive particles detector; and
an interface connecting said computer system and said explosive particles detector.

17. A explosive particles detector system as recited in claim 16, wherein said interface comprises:
a diode laser supply transforming continuous diode laser current for explosive particles detector;
a resistance-voltage transformer providing good thermal contact with diode laser;
a peltier current supply providing power amplifier for pump current; and
photodetector transformer/amplifier unit for interfacing between a photodetector and an explosive particles controller.

18. The computer program product in a computer readable medium for an explosive particles detector comprising:
instructions for signal processing for generating the diode laser current pulses;
instructions for stabilizing diode laser temperature wherein diode laser radiation is tunable by adjusting the temperature of said diode laser; and
instructions for calculating explosive particles concentration detected by said explosive particles detector.

19. The computer program product recited in claim 18, where in said instructions for signal processing further comprises:
first instructions for setting pattern of current pulses;
second instructions for storing pattern in a buffer memory; and
third instructions for applying pattern to a digital to analog converter.

20. The computer program product recited in claim 18, wherein said instructions for temperature stablilization further comprises:
first instructions for setting initial diode laser temperature by thermistor;
second instructions for switching to line stabilization position;
third instructions for receiving signal from reference signal;
fourth instructions for calculating the line position of the reference signal;
fifth instructions for determining peltier current from the line position; and
sixth instructions for applying peltier current to a digital to analog converter.

21. The computer program product recited in claim 18, wherein said instructions for calculating gas molecule concentration further comprises:
first instructions for receiving sampled data from said explosive particles detector;
second instructions for checking and comparing said sampled data with predetermined fourier transform featuring absorption of said explosive particles and absorption a predetermined molecule content in a reference cell;
third instructions for producing distinctive channels;
fourth instructions for separating the channel containing the detected explosive particles according to discrete pulses of a diode laser current;
fifth instructions for generating an odd and even arrays from said explosive particles channel;
sixth instructions for subtracting zero signal from odd array;
seventh instructions for subtracting zero signal from even array;
eighth instructions for calculating the logarithm of even over odd ratio; and
ninth instruction for mutual ortogonalization of said gas molecule to be detected and content in the reference cell thereby, the concentration of explosive particles is calculated.
